(19) United States
(12) Patent Application Publication
(10) Pub. No.: US 2014/0214492 A1
(43) Pub. Date: Jul. 31, 2014

(54) SYSTEMS AND METHODS FOR PRICE POINT ANALYSIS

(71) Applicant: Vendavo, Inc., Mountain View, CA (US)

(72) Inventors: Eric Bergerson, Forest Hills, NY (US); Thomas Sean Cowen, Mahwah, NJ (US); Megan Kurka, Port Washington, NY (US)

(73) Assignee: Vendavo, Inc., Mountain View, CA (US)

(21) Appl. No.: 14/172,923

(22) Filed: Feb. 5, 2014

Related U.S. Application Data
(63) Continuation-in-part of application No. 13/907,860, filed on Jun. 1, 2013.
Application No. 13/907,860 is a continuation of application No. 10/857,262, filed on May 28, 2004, now Pat. No. 8,458,060.

(51) Int. Cl. G06Q 30/02

(52) U.S. Cl. CPC G06Q 30/0206
USPC 705/7.35

(57) ABSTRACT

The present invention relates to systems and methods for price point analysis which identifies dynamic root dimensional causes and enables identification of opportunities. Price point analysis includes analyzing transactions to generate a data set of transactions, identifying a primary waterfall cause of the data set, and lastly generating a discrete root dimensional cause classification by setting the primary waterfall cause as a dependent variable and all other dimensions as independent variables, and clustering the transactions into segments along dimensional boundaries that best explain the primary waterfall cause, thereby identifying the root cause and its location. In some embodiments, the transactions may be pre-processed before analyzing.

### CROSS REFERENCE TO RELATED APPLICATIONS

This application is a continuation-in-part of U.S. patent application Ser. No. 13/907,860, filed on Jun. 1, 2013, by Niel Esary et al., entitled “System and Method for Organizing Price Modeling Data using Hierarchically Organized Portfolios”, currently pending, which is a continuation of U.S. patent application Ser. No. 10/857,262, filed on May 28, 2004, by Niel Esary et al., entitled “System and Method for Organizing Price Modeling Data using Hierarchically Organized Portfolios”, now U.S. Pat. No. 8,458,060, which applications are incorporated herein in their entirety by this reference.

This application is related to co-pending application Ser. No. ______, filed Feb. 5, 2014, by Eric Bergerson et al., entitled “Systems and Methods for Waterfall Adjustment Analysis” which application is incorporated herein in its entirety by this reference.

### BACKGROUND

The present invention relates to business to business market price control and management systems. More particularly, the present invention relates to systems and methods for analyzing sets of transactions in order to identify the root cause of a profit problem, and the dimensional location of that problem in a business. A profit problem is where a business is not maximizing profitability due to inefficiencies, judgment errors, or flawed policies. These classifications may enable higher order analyses of the transaction data in order to allow for guidance of negotiation and pricing optimization.

There are major challenges in business to business (hereinafter “B2B”) markets which hinder the effectiveness of classical approaches to analyzing pricing impacts and thus optimization or guidance of pricing strategies. Classical approaches to price optimization typically rely upon databases of extensive transaction data which may then be modeled for demand. The effectiveness of classical price optimization approaches depends upon a rich transaction history where prices have changed, and consumer reactions to these price changes are recorded. Thus, classical price optimization approaches work best where there is a wide customer base and many products, such as in Business to Consumer (hereinafter “B2C”) settings.

Unlike B2C environments, in B2B markets a small number of customers represent the lion's share of the business. Managing the prices of these key customers is where most of the pricing opportunity lies.

One approach to analyzing B2B markets for the generation of pricing opportunity insights through the understanding of root causes. Root cause is the identification of the part of the waterfall where margin leakage is coming from. In addition to determining root cause, the root dimensional causes may likewise be determined. Root dimensional cause involves identifying the location of the problem. This provides the ability to generate meaningful segments of transactions in order to identify opportunities for value recovery.

Unfortunately, traditional segmentation either is performed by seasoned individuals using acquired business acumen, or typically employs clustering by similar product characteristics in very simplistic hierarchies (which may be unrelated to the cause of profit problems). These product segmentation mechanisms may be adequate for generating segments under some circumstances, but seldom generate clear opportunities where value may be effectively recovered, due to the fact that they are unreflective of margin leakage or other profit problems.

As such an urgent need exists for systems and methods for price point analysis. Such systems and methods enable an improvement in profitability through enhanced opportunity identification and value recovery.

### SUMMARY OF THE INVENTION

The present invention discloses business to business market price control and management systems. More particularly, the present invention teaches systems and methods for price point analysis which identifies dynamic root causes and the segment which identifies the location of a problem within the business.

In some embodiments, the method includes analyzing transactions to generate a data set of transactions, identifying a primary waterfall cause of the data set, and lastly generating a discrete root dimensional cause classification by setting the primary waterfall cause as a dependent variable and all other dimensions as independent variables, and then clustering the transactions into segments along dimensional boundaries that best explain the primary waterfall cause, thereby identifying the root cause and its location. In some embodiments, the transactions may be pre-processed before processing to allow for the examination of adherence to specific business hypotheses.

Pre-processing includes grouping raw transactions by an aggregation dimension, calculating a discrimination value for each group of raw transactions, and comparing the discrimination value against a discrimination threshold. If the discrimination value is below a threshold then all transactions are sent for analysis. However, if the discrimination value is above the threshold then the transactions within the groups are filtered by percentile limits and conditional filters. Transactions that are not removed by filtering are then used for analysis.

Analysis includes grouping source transactions by a split dimension, calculating lift target values for each group based on a decision test value applied to a distribution of decision derived measures, and filtering to only those within the lift target values. This results in a data set that may be employed for further analysis.

Identifying a primary waterfall cause is done by calculating the waterfall lift target value for each waterfall adjustment. These values are those found at the waterfall test value percentile of the distribution of the waterfall derived measures for each waterfall adjustment across all transaction in each group. A primary root cause is assigned to each transaction. For each transaction, the primary waterfall cause is the waterfall adjustments whose waterfall lift, the difference between the value for that adjustment and the waterfall lift target value for that adjustment is largest.

With each transaction now annotated with a primary waterfall root cause, the analysis determines the location of these problems in profitability by clustering the transactions to best describe the different causes. The result is an opportunity for profit improvement that describes both the dominant root waterfall cause and the root dimensional cause describing the segment that best describes the transactions with this profitability issue.

For each opportunity the following information is calculated: the root dimensional cause, the number of transaction within it, the total value of recoverable lift for the opportunity, the percentage of recoverable lift for the opportunity, the dominant root waterfall cause for the opportunity, the improvable recoverable lift for the opportunity, and the improvable waterfall lift for the opportunity. Opportunities may be sorted by improvable waterfall lift, and those with the greatest improvable waterfall lift are displayed.

Note that the various features of the present invention described above can be practiced alone or in combination. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a simple graphical representation of an enterprise level pricing environment, in accordance with some embodiments;

FIG. 2 is a simplified graphical representation of a price modeling environment where an embodiment of the present invention may be utilized;

FIG. 3 is a simplified graphical representation of dataflow within a price modeling environment where an embodiment of the present invention may be utilized;

FIG. 4 is a flow chart illustrating a technique for quote generation, in accordance with some embodiments;

FIG. 5 is a schematic of a portfolio hierarchy, in accordance with some embodiments;

FIG. 6 is an example schematic diagram illustrating an enterprise pricing system, in accordance with some embodiments;

FIG. 7 is a more detailed example block diagram of a price analytics on transaction analysis engine, in accordance with some embodiments;

FIG. 8 is a more detailed example block diagram illustrating the transaction filter, in accordance with some embodiments;

FIG. 9 is a more detailed example block diagram illustrating the clustering analytic, in accordance with some embodiments;

FIG. 10 is a flow chart illustrating an exemplary method for price point analysis, in accordance with some embodiments;

FIG. 11 is a flow chart illustrating an exemplary, and optional, method for the step of pre-processing transaction data of FIG. 10;

FIG. 12 is a flow chart illustrating an exemplary method for the step of the main filtering and analysis process of FIG. 10;

FIG. 13 is a flow chart illustrating an exemplary method for the step of root waterfall causation classification of FIG. 10;

FIG. 14 is a flow chart illustrating an exemplary method for the step of discrete root dimensional cause classification of FIG. 10;

FIG. 15 is a flow chart illustrating an exemplary method for waterfall adjustment analysis, in accordance with some embodiments;

FIG. 16 is a flow chart illustrating an exemplary method for the step of the main analysis process of FIG. 15;

FIG. 17 is a flow chart illustrating an exemplary method for the step of root waterfall causation classification of FIG. 15;

FIG. 18 is a flow chart illustrating an exemplary method for the step of continuous root dimensional cause classification of FIG. 15; and

FIGS. 19A and 19B are example illustrations of a computer system capable of embodying the current invention.

### DETAILED DESCRIPTION

The present invention will now be described in detail with reference to selected preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Enterprise Architecture

Price protection and pricing caps have particular benefit in the B2B environment in that B2B markets often rely upon thin margins, large volumes and are often subject to swings in prices for raw materials. Thus, a brief overview of such enterprise architecture will be provided in order to properly orient the reader.

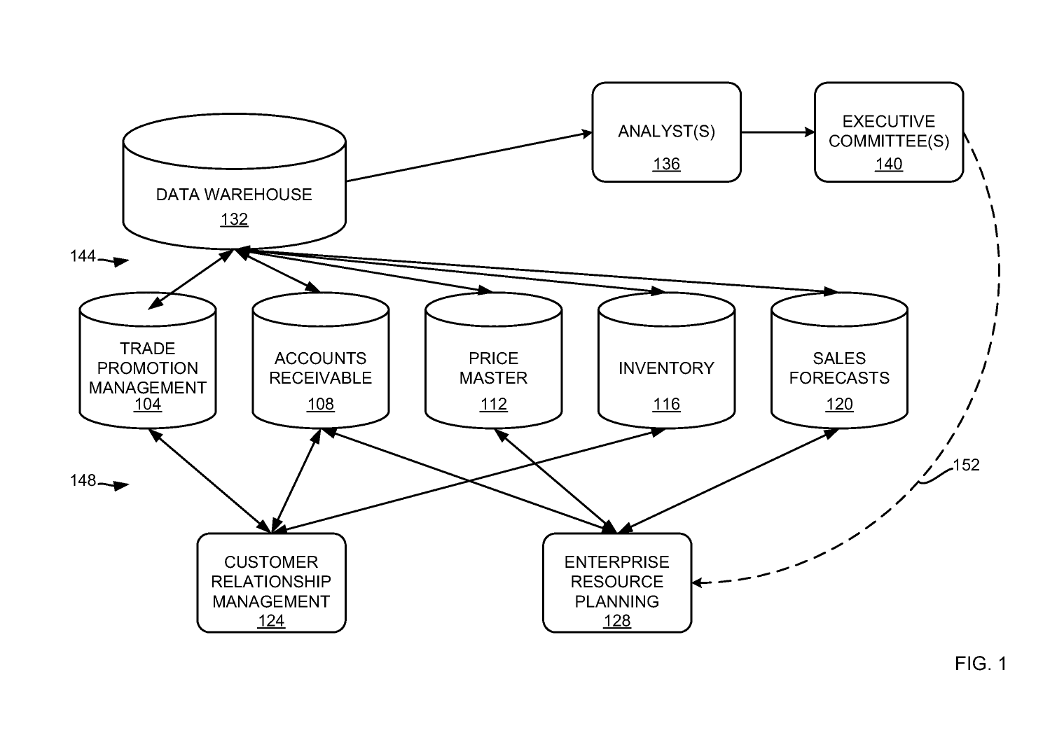

To facilitate discussion, FIG. 1 is a simplified graphical representation of an enterprise pricing environment. Several example databases (104-120) are illustrated to represent the various sources of working data. These might include, for example, Trade Promotion Management (TPM) 104, Accounts Receivable (AR) 108, Price Master (PM) 112, Inventory 116, and Sales Forecasts 120. The data in those repositories may be utilized on an ad hoc basis by Customer Relationship Management (CRM) 124, and Enterprise Resource Planning (ERP) 128 entities to produce and post sales transactions. The various connections 148 established between the repositories and the entities may supply information such as price lists as well as gather information such as invoices, rebates, freight, and cost information.

The wealth of information contained in the various databases (104-120) however, is not “readable” by executive management teams due in part to accessibility and in part to volume. That is, even though the data in the various repositories may be related through a Relational Database Management System (RDMS), the task of gathering data from disparate sources can be complex or impossible depending on the organization and integration of legacy systems upon which these systems may be created. In one instance, all of the various sources may be linked to a Data Warehouse 132 by various connections 144. Typically, the data from the various sources is aggregated to reduce it to a manageable or human comprehensible size. Thus, price lists may contain average prices over some selected temporal interval. In this manner, the data may be reduced. However, with data reduction, individual transactions may be lost. Thus, CRM 124 and ERP 128 connections to an aggregated data source may not be viable

Analysts 136, on the other hand, may benefit from the aggregated data from a data warehouse. Thus, an analyst 136 may compare average pricing across several regions within a desired temporal interval and then condense that analysis into a report to an executive committee 140. An executive committee 140 may then, in turn, develop policies directed toward price structuring based on the analysis returned from an analyst 136. Those policies may then be returned to CRM 124 and ERP 128 entities to guide pricing activities via some communication channel 152 as determined by a particular enterprise.

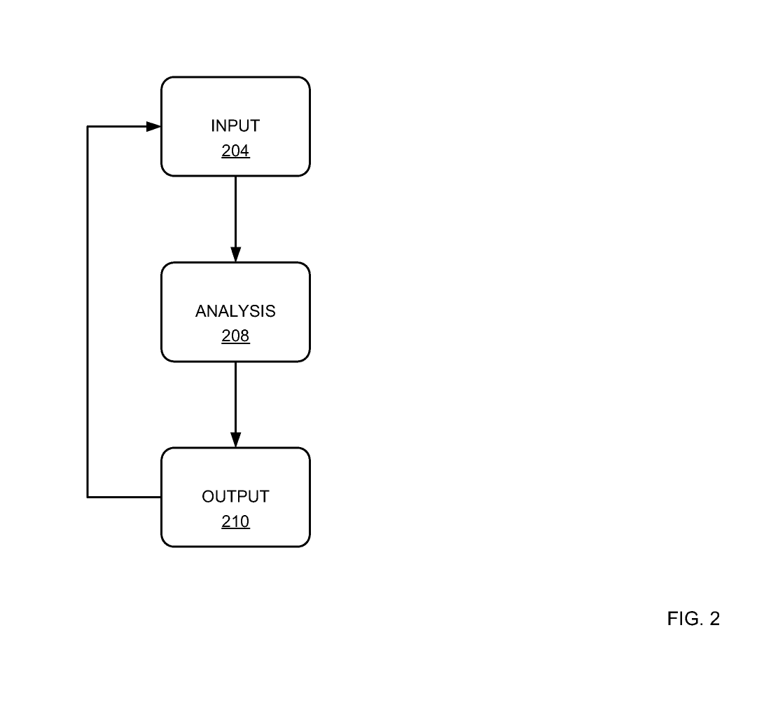

FIG. 2 illustrates a simplified graphical representation of a closed-loop system. As can be appreciated closed-loop systems are common in, for example, the mechanical and electromechanical arts. In general, a closed-loop system is a control system in which the output is continuously modified by feedback from the environment. As illustrated, for example, an input at a step 204 would be a feedback element. Inputs may be any desired indicator or metric that is measurable in some way. For example, an input may be a temperature reading taken from a thermocouple sensor. The input is then analyzed at a step 208. Many types of analysis are available depending on the intended use. Simple comparison against a set value is one example. Another example might include advanced statistical analysis where appropriate. Thus, as can be appreciated, analysis in closed-loop systems may be highly complex.

An output is generated next at a step 210 based on the analysis of step 208. An output may be any operation that is intended to affect a condition of the desired system. In the above thermocouple example, a temperature may be read (e.g., input); compared against a set temperature (analysis); and affected by turning on or off a heating element depending on the comparison (output). Finally, the system loops back to the input and continues until the system, or a user terminates the process.

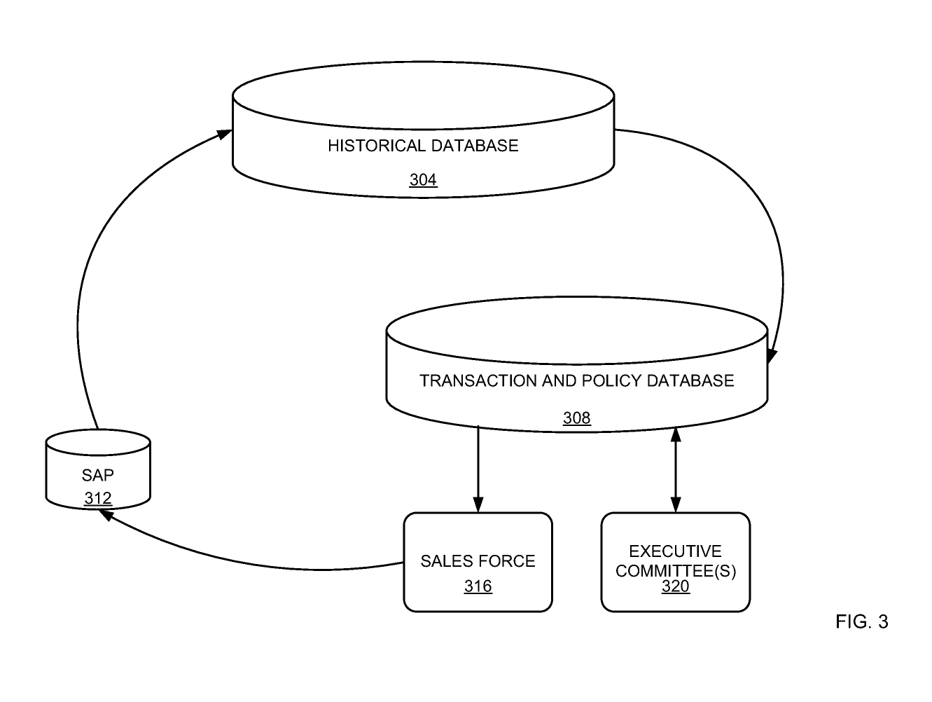

As pertains to the present disclosure, FIG. 3 is a simplified graphical representation of a closed-loop implementation of an embodiment of the present invention in a price modeling environment. At a first step 304, data is input into a historical database. A historical database, under the present invention may contain any of a number of inputs. In one embodiment of the present invention, a historical database may include sales transactions. In other embodiments of the present invention, a historical database may include waterfall records. A group of associated waterfall records may be defined as a price adjustment continuum. For example, in a transactional sales environment, an invoice price from a transaction may be affected by a rebate such that: invoice price=retail price−rebate. In this example, one waterfall record is a rebate. The rebate represents a price adjustment to the retail price that affects the invoice price. Rebate may also be thought of as a “leakage” in that the profitability of a sale is indirectly proportional to the amount of leakage in a given system. In a price modeling environment, metrics, like rebates for example, that may affect the profitability of a transaction, may be stored at a transaction level in a historical database. Many waterfall records may exist for a transaction like, for example: industry adjustments, sales discretion, shipping charges, shipping allowances, late payment costs, extended terms costs, consignment costs, returns, packaging costs, base material costs, additive costs, processing costs, variable costs, shortfalls, overages, and the like.

The analysis of the data may then automatically generate a policy database 308. For example, analysis of a selected group of transactions residing in a historical database may generate a policy that requires or suggests a rebate for any sale in a given region. In this example, some kind of logical conclusion or best guess forecast may have determined that a rebate in a given region tends to stimulate more and better sales. This policy is thus guided by historical sales transactions over a desired metric—in this case, sales by region. The policy may then be used to generate logic that will then generate a transaction item.

In this manner, a price list of one or many items reflecting a calculated rebate may be automatically conformed to a given policy and stored for use by a sales force, for example. In some embodiments, policies are derived strictly from historical data. In other embodiments, policies may be generated ad hoc in order to test effects on pricing based hypothetical scenarios. In still other examples, executive committee(s) 320, who implements policies, may manually enter any number of policies relevant to a going concern. In this manner, policies may be both automatically and manually generated and introduced into the system.

After transactions are generated based on policies, the transactional portion of the database may be used to generate sales quotes by a sales force 316 in SAP 312, for example. SAP may then generate a sales invoice which may then, in turn, be used to further populate a historical database 304, which closes the loop. In some embodiments, sales invoices may be constrained to sales quotes generated by a transaction and policy database. That is, as an example, a sales quote formulated by a sales force 316 may require one or several levels of approval based on variance (or some other criteria) from policies stored in a transaction and policy database 308. In other embodiments, sales invoices are not constrained to sales quotes generated by a transaction and policy database.

By applying closed-loop logic to a price modeling environment, pricing advantages may be achieved. In one example, workflow efficiencies may be realized where “successful” sales are tracked and policies supporting activities corresponding to the “successful” sales are implemented. The determination of “successful” in terms of a sale may be defined in any of a number of ways including, for example, increased profitability or volume. In this manner, an enterprise allows real market results to drive sales' policy rather than basing policy solely on theoretical abstractions. In other examples, hypothetical changes to policies may be tested. Thus, for example, a suggested policy requiring a rebate for any sale over $1000.00 may be implemented to test the effect on overall margins without actually modifying existing policies. In that case, a suggested policy change may reveal insight into future sales transactions that result in no net effect on margins, or may reveal insight into areas that require further adjustment to preserve or increase margins.

Another advantage to the system is that policy may flow directly from input data in an efficient manner. Individual spreadsheets and analysis typically used in price modeling may no longer be necessary. Instead, executive committees have access to real-time data that is continually updated to reflect current sales and sales practices. Response to a given policy may be seen or inferred directly from a historical database and implemented directly on a transaction and policy database. Thus, temporal efficiencies are achieved.

In still other examples, a closed-loop system may be used to devaluate individual or grouped transactions as, for example, in a deal making context. That is, a salesperson may generate a quote for a given customer and submit that quote for comparison against a policy formulated transaction in a transaction and policy database. A comparison may reveal some basis upon which a quote may represent a profitable deal. In some embodiments, a deal indicator may be generated. A deal indicator may be a ratio of the quote against a composite index that generates a value between 0 and 1 corresponding to profitability. In this example, a ratio returning unity (i.e., 1) indicates a deal is in conformance with established policy. It may be appreciated that a ratio may be defined in any of a number of manners without departing from the present invention.

In other embodiments, a deal suggestion may be generated. A deal suggestion may provide a range of acceptable (i.e., profitable) pricing based on quote parameters. Thus, a quote having deal specific set parameters like, for example, a fixed shipping price may return a range of allowable rebates or a range of allowable sales discretion that account for a fixed shipping input. In still other embodiments, deal guidance may be provided. Deal guidance provides non-numeric suggestion for a given quote. Thus, deal guidance might, for example, return “acceptable deal,” or “unacceptable deal” in response to a given quote. Policy considerations underlie deal indicators, deal suggestions, and deal guidance. Availability of these comparisons allows a user to select a comparison best fitted to their sales techniques and preferences which may result in sales efficiencies.

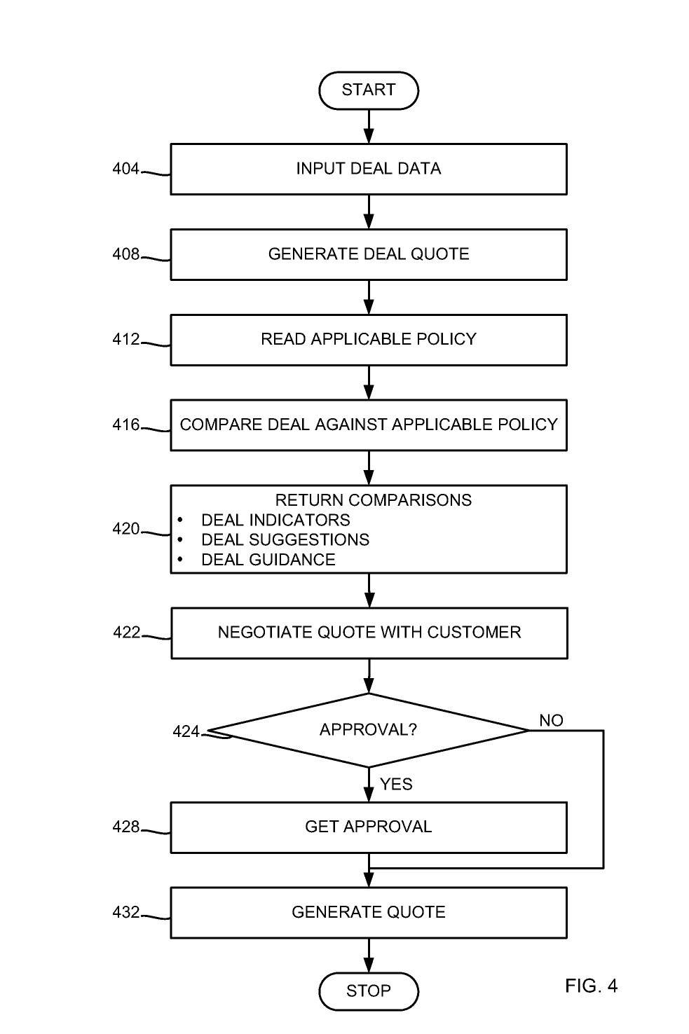

An example embodiment of the present invention using a closed-loop system is next presented. FIG. 4 is a flow chart of an embodiment of the present invention based on a closed-loop system. At a first step, 404 deal data is input into the system. Deal data may include any of a number of inputs like, for example, shipping costs, rebate, discounts, and the like. A deal quote may then be generated at a step 408 calculated from the deal data input at a step 404 and further including any missing field items based on policy considerations. Applicable policy is then read at a step 412. Applicable policy may be automatically selected or user selected by a particular metric. For example, policy may be utilized based on global metrics or may be delimited by region.

After the applicable policy is read at a step 412, a deal quote may then be compared against applicable policy at a step 416. As noted above, a comparison may reveal some basis upon which a quote may represent a profitable deal. Comparisons are then returned for review by a user at a step 420. As noted above, comparisons may include deal indicators, deal suggestions, and deal guidance. An advantage of returning a comparison is that a complex analysis may be reduced to a readily ascertainable form. In this case, a deal indicator may return a ratio; a deal suggestion may return an acceptable range of values; and deal guidance may return a non-numeric suggestion for a given deal. Thus, a deal maker may determine, at a glance, the acceptability based on policy of a given quote.

Once comparisons are returned at a step 420, a quote may be negotiated at a step 422 that may or may not incorporate any or all of those corresponding comparisons. In this manner, a salesperson negotiating a deal may flexibly structure a deal with confidence that the deal may be constrained to comparison parameters resulting in a profitable deal for an enterprise. In one embodiment, entering a negotiated transaction initiates a recalculation of comparisons. Thus, a deal maker may view real-time changes to a deal structure as a deal is being formed. This feature is particularly useful in that final negotiating point parameters may be expanded or contracted as a deal progresses providing a deal maker with an increasingly better defined negotiating position.

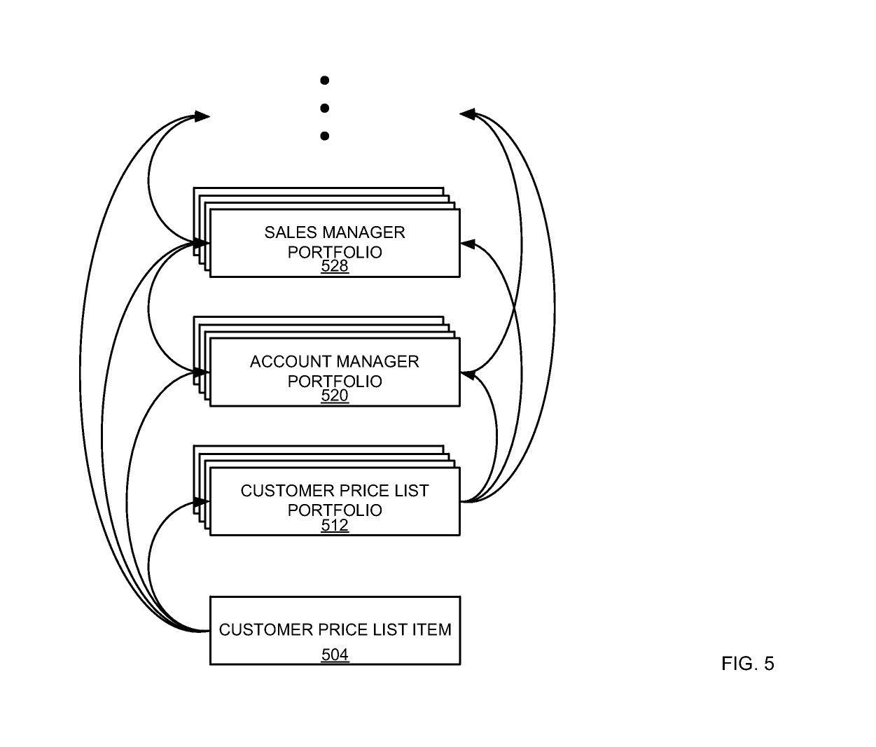

After a quote negotiation is complete at a step 422, the method determines whether approval is needed at a step 424. Approval, in this context, may be coupled with a portfolio manager. A portfolio manager may be utilized in an embodiment of the present invention to efficiently expedite approval of pending deals. Approval may include one or more levels depending on variance from an explicit or implicit policy. That is, for a particular deal that greatly varies from a policy, higher authority must approve of that particular deal. For example, a deal offering a rebate that is within policy limits may not require approval while a similar deal offering a rebate that falls outside of policy limits by, for example, 25% may need a sales manager or higher approval. Approval may be linked upward requiring executive officer approval in some cases. Portfolio management will be discussed in further detail below for FIG. 5.

If approval is needed, then a deal must be approved at a step 428. The method then continues at a step 432 to generate a quote. If approval at a step 428 is not needed, the method continues at a step 432 to generate a quote. As can be appreciated, a quote may then be used to generate an invoice. However, an invoice may or may not match the quote upon which it is based. Rather, an invoice represents an actual sale. It is the data from an actual sale that continues to populate a historical database. The method then ends.

As noted above, a portfolio manager may efficiently expedite approval of pending deals. Enterprises, as a practical reality, have a mix of “good” and “bad” deals—good deals being defined as profitable. Evaluating deals in isolation may not maximize profits at an enterprise level. For example, industries having large fixed costs may accept a number of high volume “bad” deals in order to capture a number of low volume “good” deals resulting in an overall profit. Industries evaluating deals in isolation may not realize this benefit and thus may not be able to survive. Portfolio organization, therefore, assists, for example, sales managers maximize profitability for an enterprise by allowing those managers to view enterprise level effects of a deal or groups of deals.

As seen in FIG. 5, a schematic representation of a portfolio hierarchy in accordance with an embodiment of the present invention is provided. A customer price list item 504 exists at the root of the hierarchy as an item. Each item may be configured to require approval on a pending deal, or may be configured to ignore approval on a pending deal. The customer price list item 504 may contain any of a number of descriptive and/or numeric terms such as price, description, availability, etc., for example. In one example, customer price list items 504 may be grouped into a portfolio known as customer price list portfolio 512.

Customer price list portfolios comprise customer price list items grouped according to a desired criteria or criterion. For example, price lists may be organized by cost, by type, by distributor, by region, by function, and by any other selected parameter. In this manner, approval, as an example, for a group of items—items under $1.00 for example—may be required or ignored. By grouping items, approval processes may be retained only for selected key products. In one embodiment, one or more criteria may be utilized to organize customer price list portfolio. It can further be appreciated that many other combinations of groupings for portfolios are possible. Thus, for example, a sales manager portfolio may comprise: customer price list items 504; customer price list portfolios 512; or account manager portfolios 520 as indicated by multiple arrows in FIG. 5. Further, in this example, a customer price list portfolio 512 is a static portfolio. That is, a static portfolio does not change according to a formula or algorithm. Rather, a static portfolio is entered and modified manually. It may be appreciated that most, if not all, portfolios may either be static portfolios or dynamic portfolios.

Customer price list portfolios 512 may then be organized to generate an account manager portfolio 520. Account manager portfolios 520, in this example, comprise customer price list portfolios 512 grouped according to a desired criteria or criterion. Typically, accounts may be organized by named companies or individuals. In addition to organizing accounts by name, accounts may be organized by approval. That is, all approval accounts may be managed singly or in group thus facilitating policy implementation. For example, an account portfolio may be organized such that any account having a 12-month history of on-time transactions no longer needs approval so that approval is ignored. In this way, an on-time account may accrue a benefit of an expedited approval thus making transactions more efficient for both the sales person and the account. Further, in this example, an account manager portfolio is of the type—static portfolio. As noted above, a static portfolio does not automatically change according to a formula or algorithm.

Account portfolios 520 may be further organized to generate sales manager portfolios 528. Sales manager portfolios 528, in this example, comprise account manager portfolios 520 grouped according to a desired criteria or criterion. Typically, sales manager portfolios may be organized by named individuals or groups of individuals. In addition to organizing sales manager portfolios by name, sales manager portfolios may be organized by approval. As noted above, approval based portfolios may be managed singly or in group thus facilitating policy implementation. For example, a sales manager portfolio may be organized such that sales people with seniority no longer need approval for deals under a capped amount. In this way, sales people with more experience benefit from an expedited approval process since presumably more experienced sales people have a deeper understanding of company policies and priorities. In addition, as new policy is generated, approvals may be reinstated as a training measure so that policies may more effectively be incorporated into a workflow. In this example, a sales manager portfolio 528 is of the type—dynamic portfolio. Dynamic portfolios may be generated according to formula or algorithm. For example, a sales manager portfolio may be generated for all sales associates whose total billing exceeds a desired dollar amount. In this way, managers may creatively and efficiently differentiate productive and unproductive sales associates and may further apply varying levels of approval.

### II. Systems for Price Analytics on Transactions

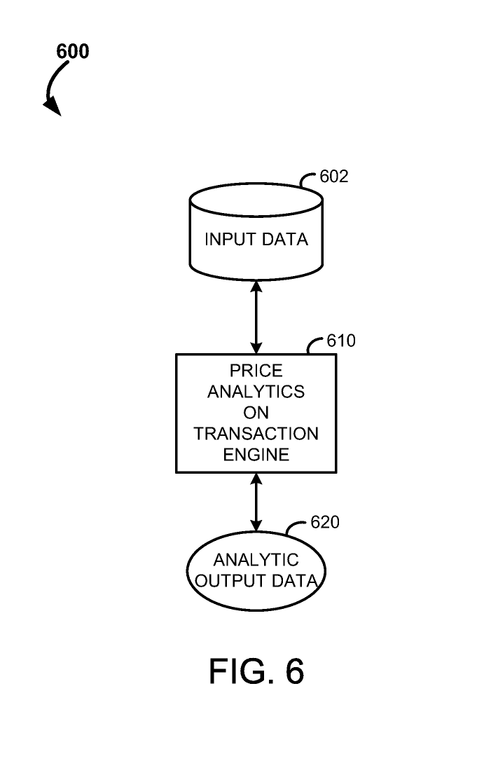

Now that the general structure of an example enterprise environment has been discussed, attention will now be focused upon the systems for price analytics on transactions. Such systems may enable price point analysis and/or waterfall adjustment analysis. To facilitate this discussion, attention is directed toward FIG. 6 where an example block diagram of the system 600 for pricing analytics is provided.

The price analytics on transaction engine 610 receives information from an input data source 602. This input data typically includes prior transaction data in addition to input parameters. Input parameters can be any of aggregation dimensions, conditional filters, discrimination denominator measure, discrimination value, waterfall denominator value, waterfall test value, split measure, decision denominator measure, decision measure, decision test value, lift denominator measure, lift measure, lift direction, lift test value, dimensional root cause termination target and dominant dimension. A dimension is a column of a pricemart that annotates each transaction with a categorical value distinct from that column. A measure is a numerical value, from or derived from the waterfall, that represents a financial or operational value of business. Examples of measures include freight recovery percentages, number of orders, etc. In addition to dimension and measure values, other transaction data may be included in the analysis, such as transaction ID, date, quantity, etc.

Aggregation dimension may include any input which is used to aggregate sets of transactions. For example, all transactions that ship to a customer may be a dimension used for aggregation. A conditional filter may include “common sense” filters which weed out erroneous transactions. Examples of conditional filters may be transactions that have quantities and/or invoice prices greater than zero. Discrimination denominator measure is the denominator utilized in calculations for filtering transactions by aggregate dimensions. Discrimination denominator measure is typically set as a price point, such as invoice price. The discrimination value includes an upper value and lower value as a configurable percentile. Often these values may be defaulted to 0% and 30% respectively. A waterfall denominator value is typically a price point, such as an invoice price or market price. Pocket Margin is often the numerator, resulting in a discrimination value representing a margin percentage (percent of the price point represented by margin). Waterfall test value is a configurable percentile, and is often defaulted to 30%, in some embodiments. The split measure is a product identifier (for example, each product can be used as a split dimension). The decision denominator measure is the denominator value used to calculate decision measure percentage. In some cases the decision measure denominator can be set to the invoice price. The decision measure is a measure used to split the subgroups of transactional data after being grouped by split dimension. An example of a decision measure is a pocket margin. The decision test value includes an upper value and lower value as a configurable percentile. The decision test value is the decision derived measure percentile used to filter the subgroups of transactional data after being grouped by split dimension. Often these values may be defaulted to 0% and 30% respectively. The lift denominator measure is another price point, while lift measure is often, again, pocket margin. Lift direction can be positive or negative. Lift test value is a configurable percentile, and is often defaulted to 30%. Dimensional root cause termination target is the percentage of overall possible lift below which clusters cannot be made smaller. In some embodiments, this clustering is performed by trees, and the termination target would then be the percentage of overall possible lift below which the tree terminates splitting. Dimensional root cause termination target is a configurable percentage, and is often defaulted to 5%. Lastly, dominant dimension is selected from the aggregation dimensions. The dominant dimension is a dimension that has to be considered a split dimension. As such, the dominant dimension is guaranteed to be an independent variable of the continuous decision tree.

The price analytics on transaction engine 610 can leverage the input data 602 to generate analytic output data 620. Periodically, the input database 602 may be updated by the price analytics on transaction engine 610 when new policy information is generated, new transaction data is available, etc.

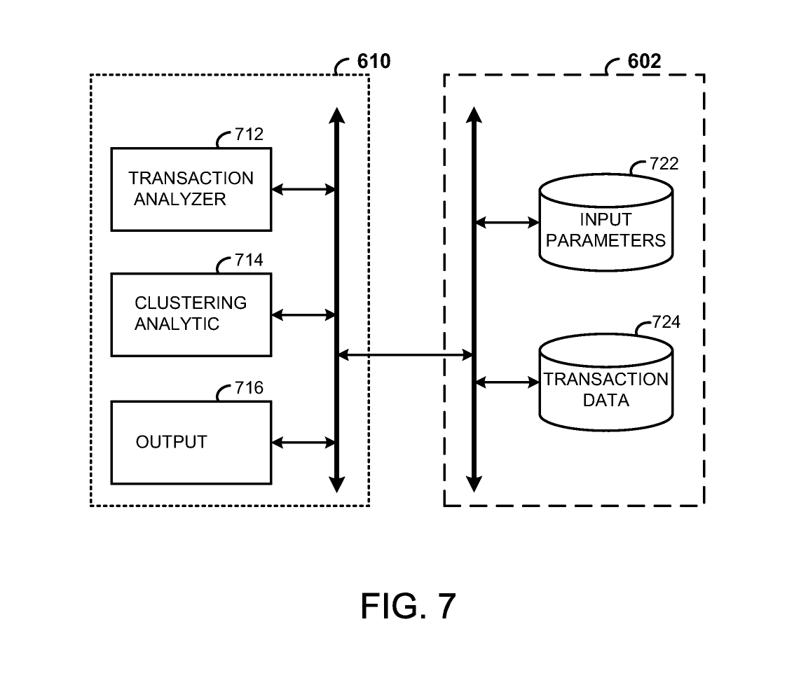

FIG. 7 provides a more detailed illustration of the price analytics on transaction engine 610, in accordance with some embodiments. In this example block diagram the price analytics on transaction engine 610 is seen as having three components logically coupled to one another. These components include a transaction analyzer 712 which processes the transaction to a filtered and analyzed output. A clustering analytic 714 utilizes the filtered and analyzed output to cluster transactions into opportunities to realize business goals, each opportunity including a root cause and location represented by a dimensional segment for refinement of business operations.

Additionally, the input database 602 is shown as including input parameters 722 (as defined above), and transaction records 724. The various modules of the price analytics on transaction engine 610 utilize these transaction records and inputs in order to generate their outputs.

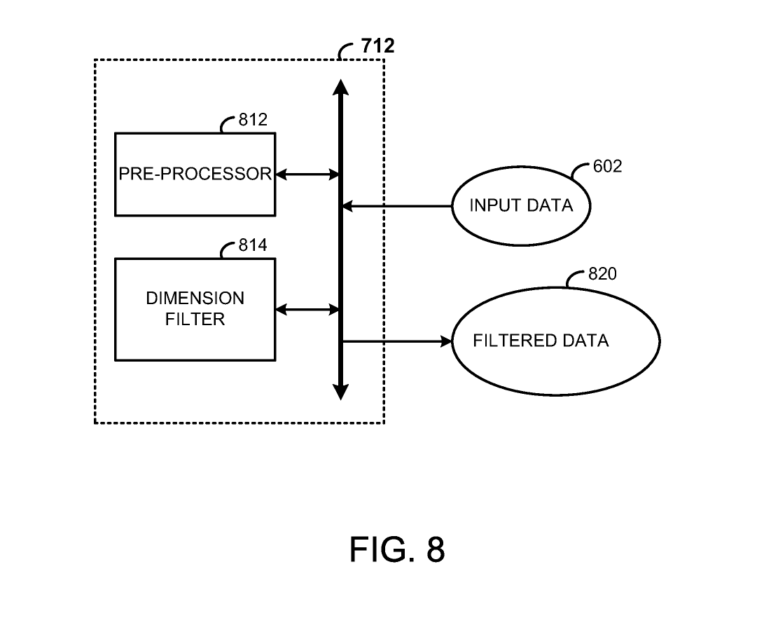

FIG. 8 is a more detailed example block diagram illustrating the transaction analyzer 712, in accordance with some embodiments. In this example diagram, the analyzer 712 is seen as including a pre-processing module 812 and a dimensional filter 814. Pre-processing of the transactions may be optionally employed in order to provide context, so that the analytics are applied to a specific subset of the data being examined. For example, in one configuration, the system only looks at Low Margin Customers, so that all of the business opportunities for margin improvement only apply to the customers who are not as meaningful to the company. The methods of pre-processing will be described in considerable detail below. The dimensional filter either takes raw input data 602, or pre-processed data and generates the filtered data 820.

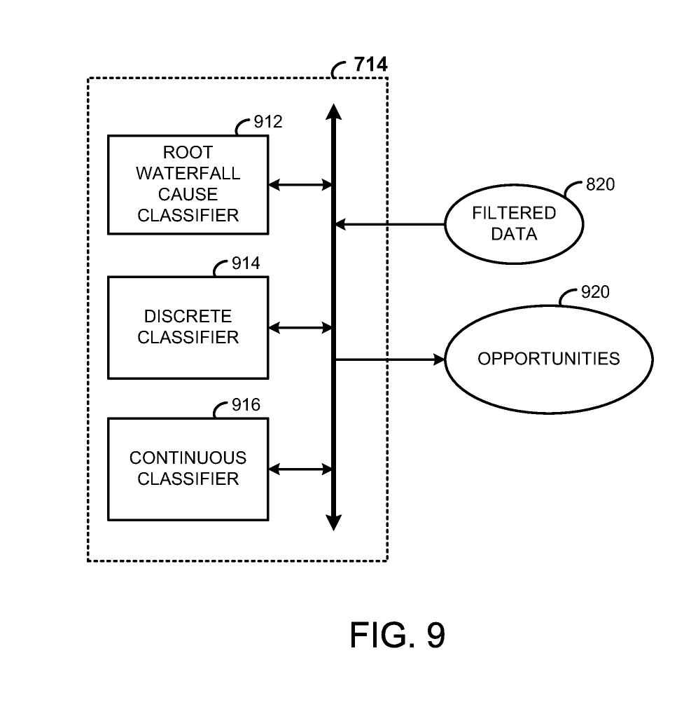

The filtered data 820 is then utilized by the clustering analytic 714, as seen in relation to FIG. 9. As can be seen, the clustering analytic includes a root waterfall cause classifier 912, a discrete classifier 914 and a continuous classifier 916. Depending upon if the systems is performing price point analysis or waterfall adjustment analysis, different modules of the clustering analytic 714 will be employed. The clustering analytic 714 locates primary dimension nodes that show a primary waterfall root cause. The ultimate output of the clustering analytic 714 are opportunities 920 and segments identified by the opportunity, which may be employed by the output 716 in order to perform further pricing analytics and management.

The opportunities generated by the clustering analytic 714 may include, but is not limited to, any of low margin analysis, slow moving product analysis, and excessive variation analysis. Each of these opportunities may be referred to as performance analytics. The root cause is the primary driver selected from a set of waterfall elements from the input data that have been chosen to be waterfall comparative measures. These are waterfall elements which can be assigned a reason for outlying performance. Lastly, the dimensional segment is a set of transactions identified by a common set of dimensional values. For example, all transactions that have a common customer, product level, or sales representative, for example.

The opportunities generated from the system are defined as a set of values. These values include the total value of the data set, total value of performance analytic, total value of the performance analytic attributed to a root waterfall cause, total value of the performance analytic in a dimensional segment, total value of the performance analytic attributed to a root waterfall cause in a dimensional segment, and transaction IDs.

The total value of the data set is the sum of lift measure values for all transactions in the data set after pre-processing (if applicable). The total value of the performance analytic, in contrast, is the sum of recoverable lift values for all transactions that meet the criteria of the performance analytic (i.e., low margin transactions, etc.). Alternatively, the total value of the performance analytic may be the sum of recoverable lift for all transactions. Recoverable lift is the monetary gap between the transaction detail and the decision measure.

The total value of the performance analytic attributed to a root waterfall cause is the sum of the improvable waterfall lift values for the individually assigned root waterfall cause of each transaction. The total value of the performance analytic in a dimensional segment is the sum of the recoverable lift values for all transactions within the dimensional segment. The total value of the performance analytic attributed to a root waterfall cause in a dimensional segment is the sum of the improvable waterfall lift values for all transactions within the dimensional segment attributed to the dominant root waterfall cause of the dimensional segment. Transaction IDs include the set of transaction IDs that are accumulated to calculate all of the above values. Each transaction ID is also associated to a root waterfall cause, improvable recoverable lift (or zero if none), and improvable waterfall lift for the root waterfall cause (or zero if none).

Methods for the price analytics on transaction engine 610 and its components shall be described in considerable detail below in relation to two discrete analytics: price point analysis and waterfall adjustment analysis. In some embodiments, these two analytics can be utilized alone, or in combination, in order to drive further analyses which in turn support business use cases.

### III. Methods of Price Point Analysis

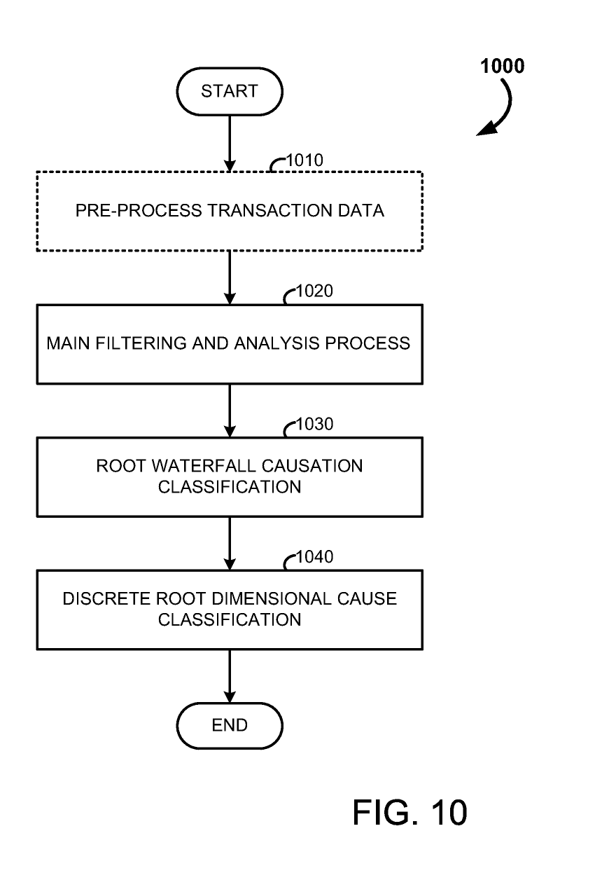

To further facilitate the discussion of some embodiments, attention will be turned to FIG. 10, which provides a high level flowchart 1000 for the method of price point analysis. Price points, in a price waterfall, are a combination of metrics that represent a specific profitability or price concept. For example, invoice price, pocket margin and pocket price are all examples of price points.

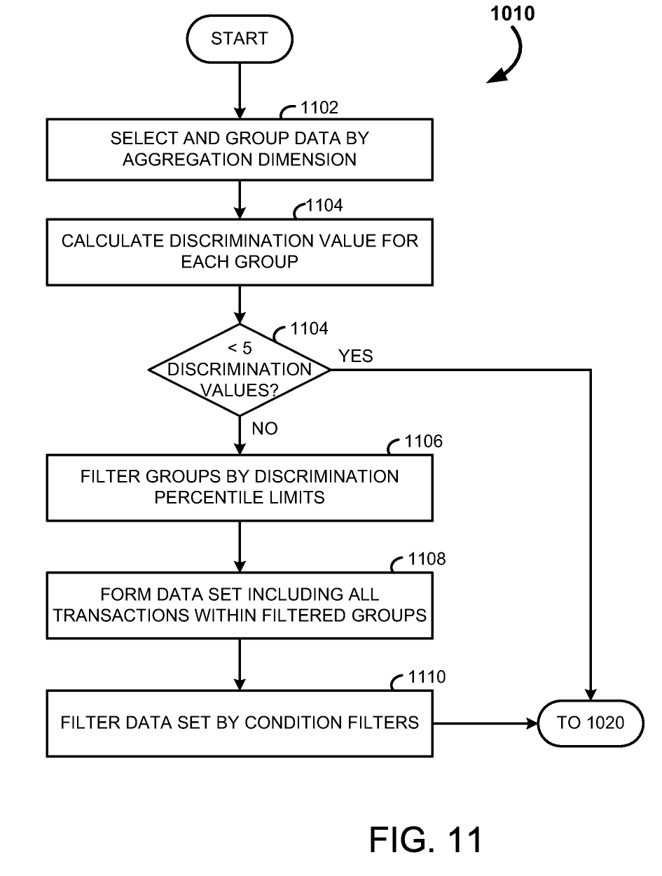

In this example of price point analysis, initially an optional pre-processing of transaction data may be employed (at 1010). FIG. 11 is a flow chart illustrating an exemplary method for the step of pre-processing transaction data of FIG. 10. In pre-processing the input data is grouped by the aggregation dimension (at 1102). For example, if the aggregation dimension is set to “ship to customer” all transactions would be aggregated by the customer to whom they were shipped. For each of these aggregated groups, a discrimination value is calculated (at 1104). Discrimination value is calculated in a myriad of ways. For example, if there is no discrimination denominator measure present then the discrimination value is the sum of discrimination measures (pocket margin in some embodiments). However, if a discrimination denominator is present, the discrimination value is set equal to the sum of discrimination measures divided by the sum of discrimination denominator measures.

Alternatively, a variation discrimination value may be calculated, where if there is no discrimination denominator measure present then the discrimination value is the standard deviation of discrimination measures divided by the mean of the discrimination measure. Moreover, if a discrimination denominator is present, the discrimination value is set equal to a discrimination measure divided by the discrimination denominator measure; alternatively, the discrimination value may equal the sum of discrimination denominator measures multiplied by the standard deviation of derived discrimination measure divided by the mean of the derived discrimination measure.

Next the method queries if less than five distinct discrimination values are present (at 1104). While the number five is employed herein for the limit for pre-processing, this threshold value may, of course, be configured. If there are not at least five discrimination values, then the pre-processing terminates, and the process continues without further pre-processing. However, where there are more than four distinct discrimination values, then the process continues to where the groups are filtered by the discrimination percentile limits (at 1106), whereby only groups that have discrimination values within the percentile limits (both lower and upper limit) are retained. These retained groups are included within a new data set (at 1108). The new dataset is then subjected to the conditional filters (at 1110) in order to further refine the data. The conditional filters eliminate specific transactions which include unwanted features (such as negative quantities).

As a result of this pre-processing, the initial input data set is trimmed to only the transactions from the groups that meet the discrimination criteria. For this example, that would mean that only the transactions from the customers identified by ShipToCustomer whose Pocket Margin % is in the bottom 20^{th} percentile of all customers, is carried forward as the current data set. It should also be noted that additional or different filters may be applied to the transactions during pre-processing, as is desired to provide better or different context to the results.

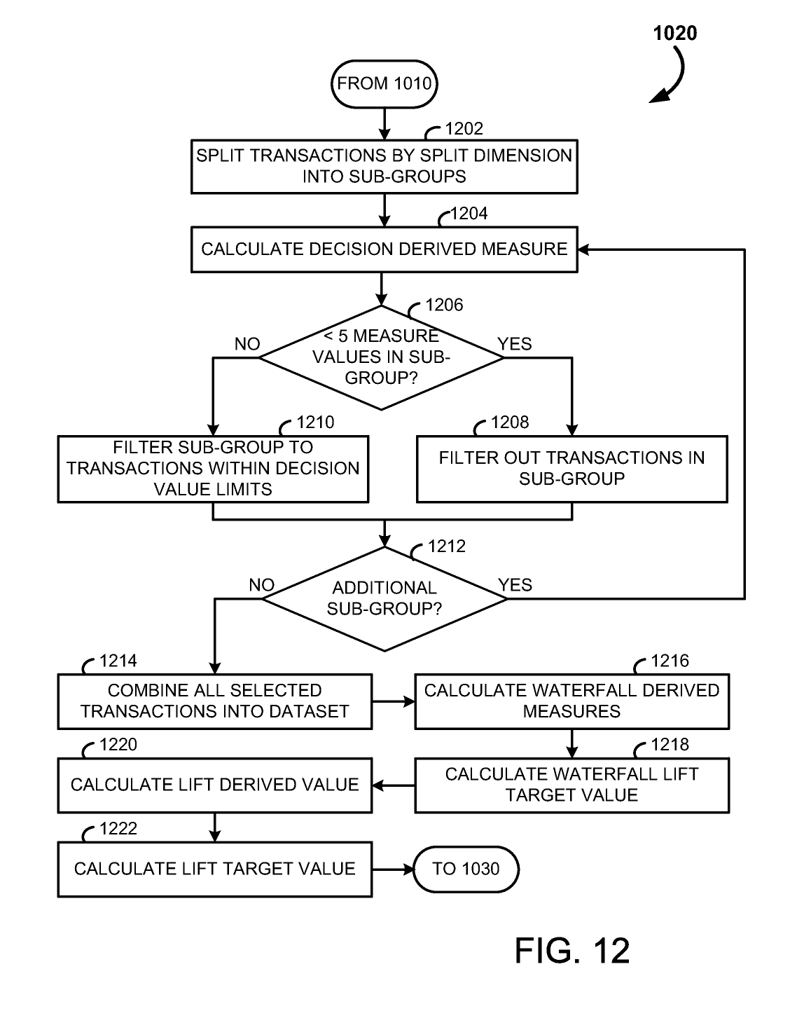

Returning to FIG. 10, after pre-processing (when applied), the next step in the process is to analyze the transactions (at 1020). FIG. 12 provides a more detailed diagram for this analysis process. Initially, the transactions are split by split dimensions into sub-groups (at 1202). As previously discussed, the split dimensions may include any criteria by which the transactions may be grouped. One such common split dimension would be by product type. After the sub-groups are formed, decision derived measure may be calculated (at 1204) by dividing the decision measure by the decision denominator measure. Next, the process may query if there are less than five measure values in a sub-group (at 1206). Of course, this threshold of five measure values may be configured to a different threshold if desired.

If the sub-group does not have greater than the threshold number of measure values, all transactions are filtered from the subgroup (at 1208). Alternatively, if there are more than five measure values in the sub-group, then the sub-group is filtered for transactions that are within decision value limits (at 1210). The process repeats for each sub-group (at 1212) until no sub-group is remaining. Next, all the transactions that passed through the filtering are combined into a dataset (at 1214). Likewise, additional or fewer filters may be applied during this analysis step, as is desired for a specific outcome.

The dataset is used to calculate a waterfall derived measure (at 1216). The waterfall derived measure is determined by dividing the waterfall comparative measure by the waterfall denominator measure. A waterfall comparative measure are those waterfall adjustments impacting the decision measure when transactions are filtered by measure per dimension. For example, if the decision measure is pocket margin, then the waterfall comparative measures would include negotiated discount, freight charge, surcharge, invoice price adjustment, rebate, net price adjustment, payment cost, freight cost, service cost, pocket price adjustments, and COGS. Each of these is then divided by the waterfall denominator measure (i.e., invoice price) to yield the waterfall derived measures.

Subsequent to calculating the waterfall derived measure, the waterfall lift target value is calculated (at 1218). The waterfall test value is a percentage and it is multiplied by each waterfall derived measure to yield the waterfall lift target value. The lift derived measure is then calculated (at 1220) by dividing the lift measure by the lift denominator measure. Lastly, the lift target value is calculated (at 1222) as the value returned by taking the lift test value percentile of the distribution of the lift derived measures. The subgroups not within the lift values may then be filtered out. The transactions from each group that are not filtered out are the ones whose Derived Decision Measure falls within these limits. So, there are three groups of limits calculated, the waterfall lift target values, the lift target value and the values for each group at the Decision Test Value percentiles.

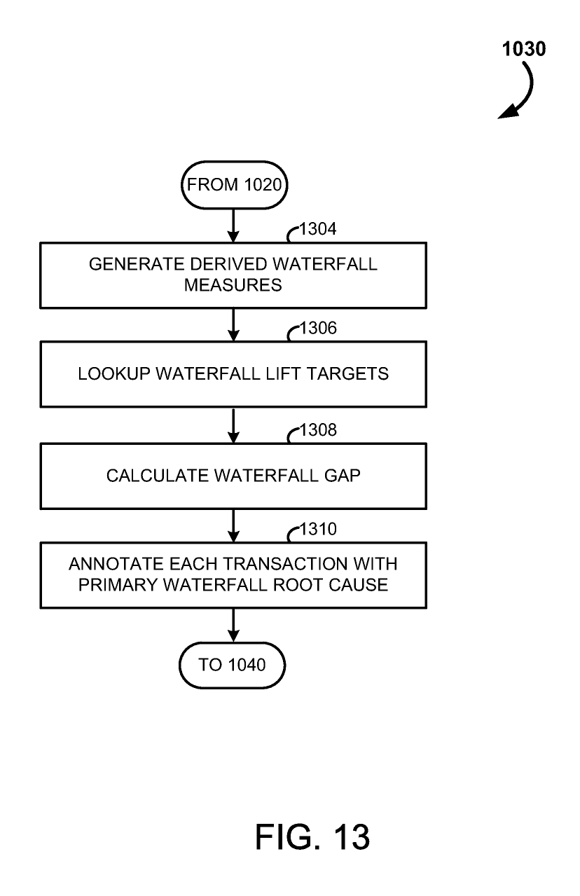

The new filtered dataset and statistics that were generated may then be employed by a root waterfall causation classification process (at 1030), as seen in FIG. 10. The goal of this process is to identify the primary waterfall reason why each transaction is part of the current data set. Transactions are tested against a norm (Waterfall Test Value) and those that move the needle most are deemed as the Waterfall Root Cause for the transaction. FIG. 13 provides a more detailed illustration for an embodiment of this process. Initially, the derived waterfall measure is derived (at 1304) by dividing the waterfall comparative measures by the waterfall denominator measure. This process may be performed as part of the analysis process as disclosed previously, in some embodiments.

Next, waterfall lift targets are identified (at 1306) by split dimension for each waterfall comparative measure. The difference between the waterfall derived measure and the waterfall lift target is calculated as the waterfall gap (at 1308). Each transaction is then annotated with the primary waterfall root cause as the adjustment with the greatest waterfall gap (at 1310). In some alternate embodiments, the cause may be derived measure across more than one adjustment.

In one example, the performance analytic is low pocket margin, so to that end, at this point, all of the transactions that remain included in the current data set are there because they are considered part of the problem of having low pocket margin (after per-processing and analysis). Each transaction may be part of this current data set for more than one waterfall reason. For example, they may have excessive rebates and also inordinate freight costs. In this example, the process assigns to each transaction the waterfall element that contributes most to the transaction being included in the current data set.

The transaction's primary root waterfall cause is identified as the derived waterfall measure with the greatest distance from the waterfall lift target value. Additionally, the recoverable lift for each transaction is calculated by finding the dollar difference between the value for the lift measure in the transaction and the lift test value for this transaction's split dimension carried forward from the last process. The transactions in the current data set are not reduced as a result of this process. Rather, as a result of this process, each transaction is annotated with three additional values, a root waterfall cause identifier, the dollars of recoverable lift, and the dollars of recoverable lift due to the identified root waterfall cause.

Returning to FIG. 10, after root waterfall causation classification, the process generates a discrete root dimensional cause classification (at 1040). The root dimensional cause identification assigns the dimensional root cause to each transaction by clustering the transactions into segments along dimensional boundaries that best explain the primary waterfall cause. This clustering may be performed, in some embodiments, by running through a decision tree. Nodes are defined by having met opportunity thresholds explained by the above root waterfall cause classification. The goal of this process is to identify meaningful segments of transactions from within the current data set that present a clear opportunity for value recovery. The segments are formed through a decision tree process that recursively examines segments of greater dimensional specificity. Each segment is analyzed for the allocation of waterfall lift based on the root waterfall cause classification.

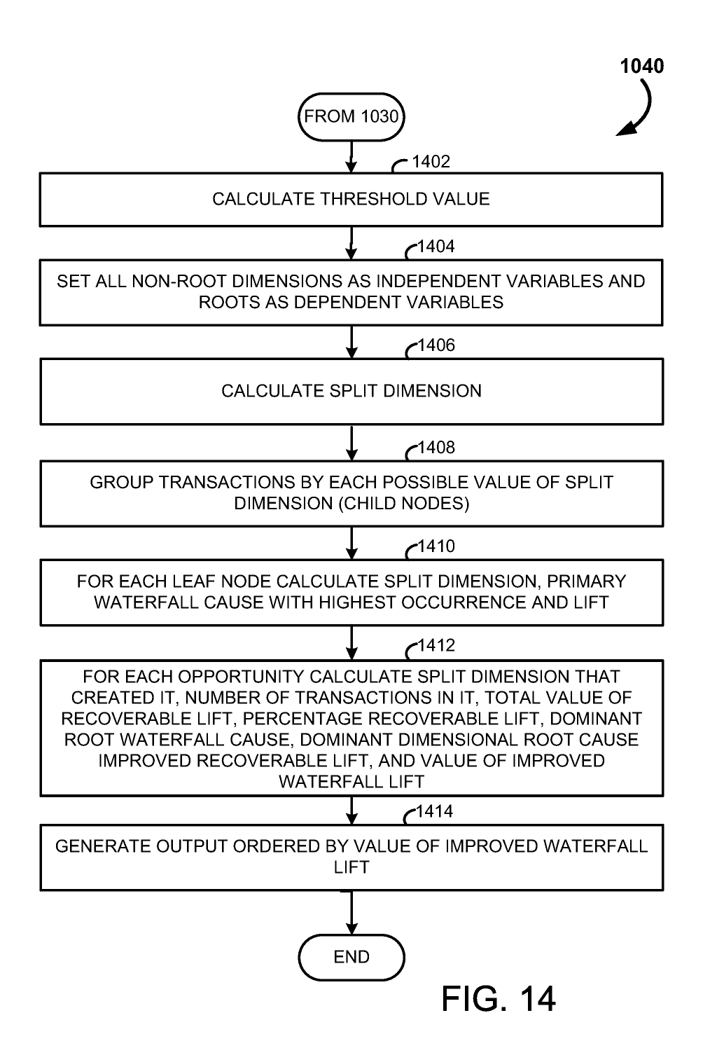

FIG. 14 provides a more detailed illustration of the discrete root dimensional cause classification process for the example embodiments, where a decision tree is employed. Initially a threshold value is calculated (at 1402) by multiplying the total improvable waterfall lift from the filtered dataset by the dimensional root cause termination target. This target is the percentage of overall possible lift below which the tree terminates splitting.

Next, the process sets all dimensions that are not roots as independent variables, and the primary waterfall root cause dimension as a dependent variable (at 1404). The root node consists of all transactions and its possible dimensions are each independent variables. Subsequently, the split dimension is calculated (at 1406) which yields the highest information gain with respect to the dependent variable for the root node.

The transactions are then grouped by each possible value of the split dimension (at 1408). These groups become child nodes, and the split dimension found in their parent node (i.e., root node) is removed from their possible split dimension. Each child node of the decision tree holds the following information: number of transactions in the node, number of transactions in the node for each primary root waterfall cause, total number of dollars of recoverable lift for each primary root waterfall cause within the node, and percentage of recoverable lift for each primary root waterfall cause within the node.

The child node continues to be split until a leaf node is reached. A leaf node exists when it has no more possible split dimensions, there is only one possible value of the dependent variable, the total improvable waterfall lift is less than the threshold value, or the maximum information gain calculated is zero. For each leaf node, the split dimension which created the leaf node is determined, the primary waterfall cause with the highest occurrence in the leaf is calculated, the primary waterfall cause with the greatest total improvable waterfall lift is calculated, and the dominant dimensional root cause is identified (at 1410). If there is more than one primary waterfall cause with the highest occurrence, the primary waterfall cause with the greatest total improvable waterfall lift is selected. The leaf node is determined to be an opportunity if there is more than one transaction in the node, and if there is one primary waterfall cause which is both the highest occurrence and has the greatest total improvable waterfall lift (known as the dominant root waterfall cause).

Next, for each opportunity the following information is calculated (at 1412): the split dimension for the opportunity, the number of transactions in the opportunity with each primary root waterfall cause, the total number of dollars of recoverable lift for each primary root waterfall cause in the opportunity, the percentage of recoverable lift for each primary root waterfall cause in the opportunity, the dominant root waterfall cause of the opportunity, the total number of dollars of improvable recoverable lift for the dominant root waterfall cause in the opportunity, and total number of dollars of improvable waterfall lift for the dominant root waterfall cause in the opportunity.

The opportunity information calculated above is ordered by the total number of dollars of improvable waterfall lift (at 1414). A number of the opportunities with the greatest improvable waterfall lift are then highlighted in the decision tree, and/or the information is displayed in tabular form. The number of opportunities output in this manner may be configurable by the user. The finished tree represents a clustering of opportunities for waterfall lift. The tree is then examined for the segments that represent the best actionable opportunities in dollars of waterfall lift. Of course, it should be understood by those skilled in the art that other clustering techniques and methods may also be readily employed instead of decision trees.

This concludes the process for discrete root dimensional cause identification. The final output and subsequent segmentation likewise finalizes the price point analysis. Segment data, and opportunity analytics may be employed to drive business decisions and for further pricing analytics.

### IV. Methods of Waterfall Adjustment Analysis

As with price point analysis, the goal of waterfall adjustment analysis is to identify meaningful segments of transactions from within the current data set that present a clear opportunity for value recovery. Unlike price point analysis, however, in the waterfall adjustment analysis the dependent variable is a derived measure calculated during the pre-process for each transaction. This derived measure is typically a continuous real number value. In contrast, in price point analysis the dependent variable is the root waterfall cause classification for each transaction, as disclosed above.

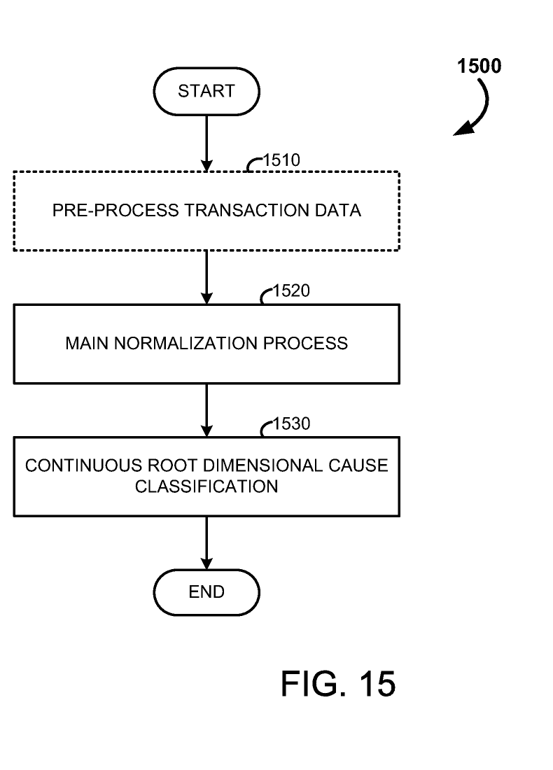

To facilitate this discussion, FIG. 15 is a flow chart illustrating an exemplary method for waterfall adjustment analysis 1500, in accordance with some embodiments. Initially, the process begins with an optional pre-processing of the transaction data (at 1510). This optional pre-processing step is substantially similar to the pre-process described above in relation to FIG. 11.

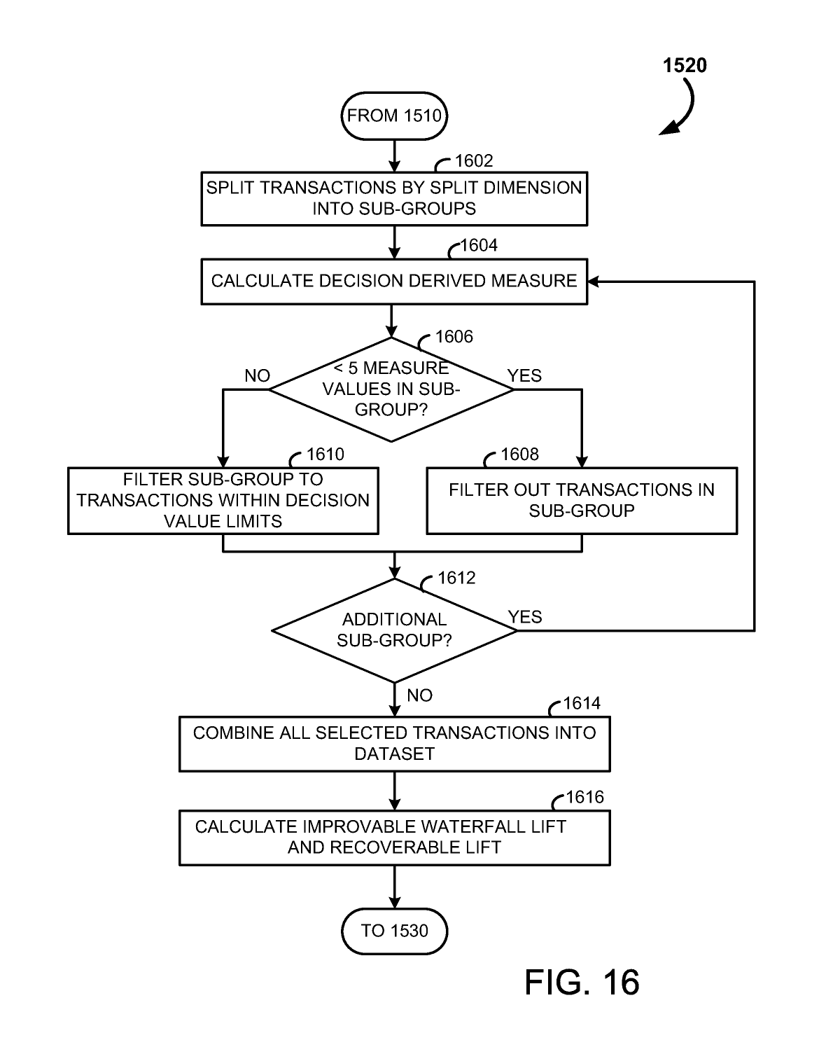

After the optional pre-processing, an analysis process is employed (at 1520). This analysis process differs from the process employed in price point analysis, and FIG. 16 provides a more detailed illustration of this analysis process. Initially, the transactions are split by split dimensions into sub-groups (at 1602). As previously discussed, the split dimensions may include any criteria by which the transactions may be grouped. One such common split dimension would be by product type. After the sub-groups are formed, decision derived measure may be calculated (at 1604) by dividing the decision measure by the decision derived measure. Next, the process may query if there are less than five measure values in a sub-group (at 1606). Of course, this threshold of five measure values may be configured to a different threshold if desired.

If the sub-group does not have greater than the threshold number of measure values, all transactions are filtered from the subgroup (at 1608). Alternatively, if there are more than the threshold number of measure values in the sub-group, then the sub-group is filtered for transactions that are within decision value limits (at 1610). The process repeats for each sub-group (at 1612) until no sub-group is remaining. Next, all the transactions that passed through the filtering are combined into a dataset (at 1614).

Lastly, the improvable waterfall lift for each adjustment and recoverable lift for each transaction are calculated (at 1616). Recoverable lift is the percentage gap between the transaction detail and the decision measure. If the lift direction is positive, the recoverable lift is defined as the lift target value subtracted from the decision derived measure. Conversely, if the lift direction is negative, the recoverable lift is defined as the decision derived measure subtracted from the lift target value.

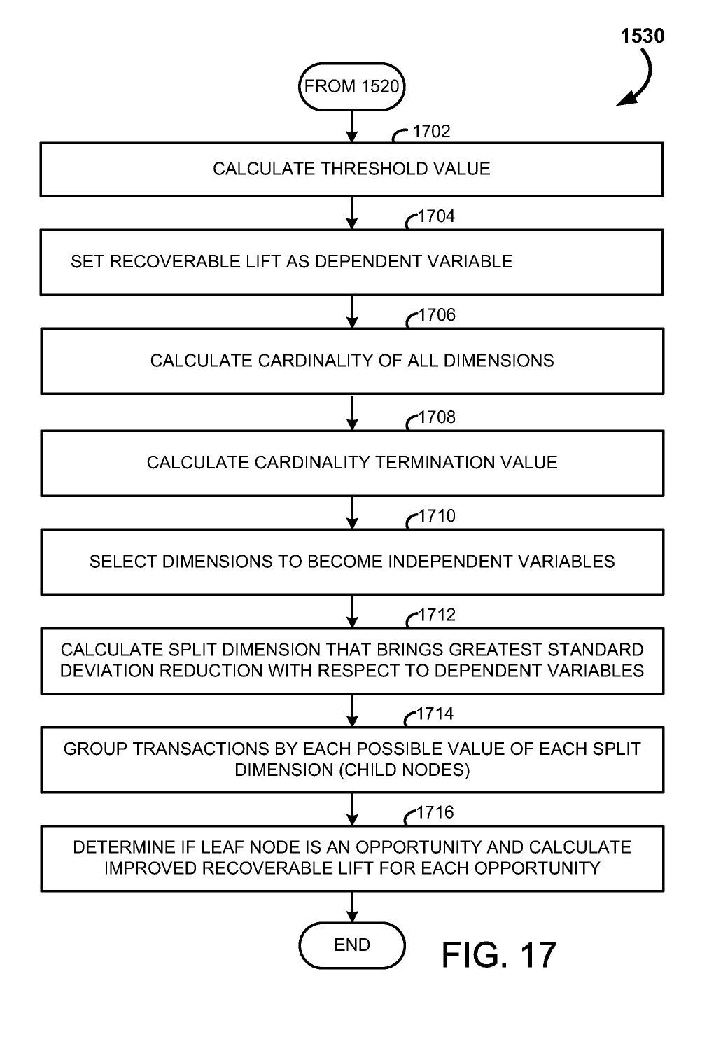

Returning to FIG. 15, after the analysis process is concluded, a continuous root dimensional cause classification is performed (at 1530). FIG. 17 provides a more detailed illustration of the continuous root dimensional cause classification. In this process, the total improvable recoverable lift is multiplied by the dimensional root cause termination target to yield a threshold value (at 1702). The recoverable lift is set as a dependent variable (at 1704). Next, the cardinality of all dimensions is calculated (at 1706). Cardinality is the number of unique values of a dimension divided by the number of transactions. Table 1, below provides an example of cardinality for a set of dimensions.

TABLE 1
Cardinality calculations

| | Number of | Cardinality | Cardinality |
|---|---|---|---|
| Dimension | Unique Values | Ratio | Percentage |
| Product level 1 | 2 | 2/40 | 0.05 |
| Product | 4 | 4/40 | 0.1 |
| Sold to Customer | 3 | 3/40 | 0.075 |
| Ship to Customer | 7 | 7/40 | 0.175 |
| Sales Rep | 6 | 6/40 | 0.15 |

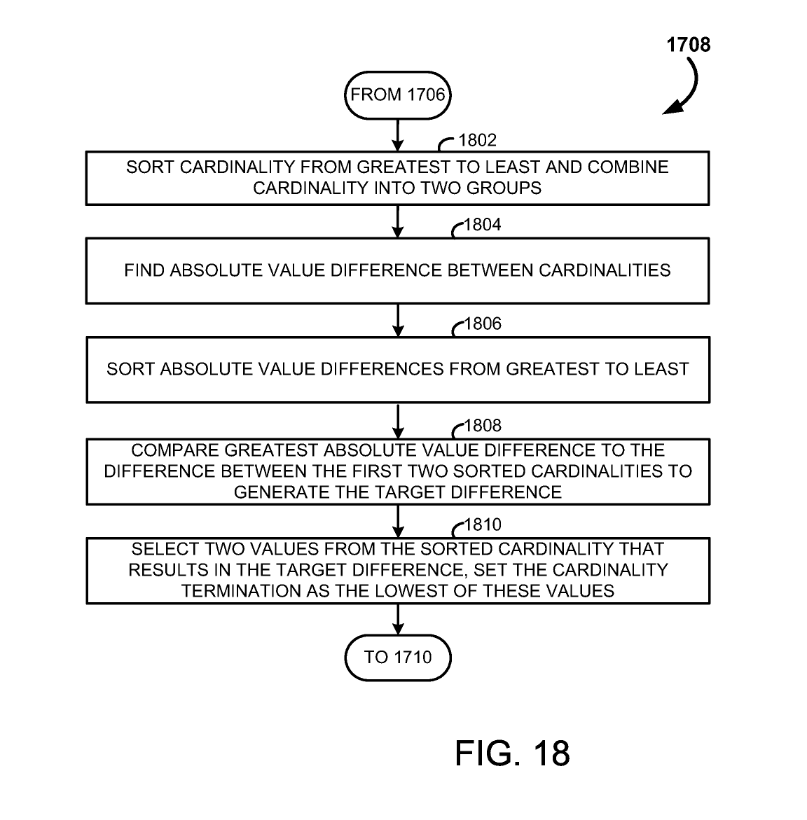

Next, the cardinality termination value is calculated (at 1708). FIG. 18 provides a more detailed illustration of the process for calculating cardinality termination value. In this sub-process, the cardinality is sorted from the greatest to the least. Table 2 provides an example of this sorting.

TABLE 2
Sorting by Cardinality

| | Cardinality |
|---|---|
| Dimension | Percentage |
| Ship to Customer | 0.175 |
| Sales Rep | 0.15 |
| Product | 0.1 |
| Sold to Customer | 0.075 |
| Product level 1 | 0.05 |

The cardinalities are then combined into two groups (at 1802). Next, the absolute value of the difference between two cardinalities is calculated (at 1804). Table 3 illustrates the grouping of the cardinalities and subsequent calculation of absolute difference.

TABLE 3
Absolute Difference calculations

| Dimension Group | Cardinality | Absolute Difference |
|---|---|---|
| Ship to Customer - Sales Rep | 0.175-0.15 | 0.025 |
| Sales Rep - Product | 0.15-0.1 | 0.05 |
| Product - Sold to Customer | 0.1-0.075 | 0.025 |
| Sold to Customer - Product level 1 | 0.075-0.05 | 0.025 |

These absolute differences are sorted from the greatest to the least (at 1806). Table 4 illustrates these example groups sorted by absolute difference.

TABLE 4
Absolute Difference sorting

| Dimension Group | Cardinality | Absolute Difference |
|---|---|---|
| Sales Rep - Product | 0.15-0.1 | 0.05 |
| Ship to Customer - Sales Rep | 0.175-0.15 | 0.025 |
| Product - Sold to Customer | 0.1-0.075 | 0.025 |
| Sold to Customer - Product level 1 | 0.075-0.05 | 0.025 |

The greatest absolute difference is compared to the difference between the first two sorted cardinalities, and if these values are not the same the difference between the first two cardinalities is defined as the target difference. Otherwise, if the absolute difference and the difference between the first two cardinalities is the same, then define the target difference as the second largest absolute difference (at 1808). In the above example, the largest absolute difference is 0.05. However, Sales rep and Product are not the top two sorted cardinalities, therefore the difference between the first two cardinalities becomes the target difference (in this example 0.05). Lastly, two values of the cardinality are selected which result in the target difference. The lower of the two values is then defined as the cardinality termination (at 1810). In this example, the cardinality chosen is Product at 0.1.

Returning to FIG. 17, after the cardinality termination value is calculated, the dimensions that are to be independent variables are selected (at 1710). Dimensions are able to be an independent variable if they are not the lowest level of a hierarchy, are selected by the user as dominant dimensions, and/or it is the lowest level of the hierarchy and its cardinality is less than or equal to the cardinality termination value.

Next, the process calculates the split dimension which has the largest standard deviation reduction with respect to the dependent variable (at 1712). The standard deviation reduction is based on the decrease in standard deviation after a dataset is split on an attribute. In order to determine the standard deviation reduction the standard deviation of the target is calculated, and the dataset is then split on the different attributes. The standard deviation for each branch is calculated. The resulting standard deviation is subtracted from the standard deviation before the split. The result is the standard deviation reduction.

The transactions are then grouped by each possible value the split dimension identified in the previous step (at 1714). These groupings become child nodes, and the split dimension found in their parent node is removed from their possible split dimensions. The child nodes hold the following information: split dimensions that created the child node, number of transactions within the node, and total value of recoverable lift.

A child node is determined to be a leaf node if it cannot be split further, the total recoverable lift is less than the threshold value, and/or if the maximum standard deviation reduction calculated for the node is zero. If the leaf node has more than one transaction in it, then it is considered an opportunity. For each opportunity the following is calculated: the split dimension that created it, the number of transactions within the opportunity, and the total value of improvable recoverable lift in the opportunity (at 1716). The opportunity information is ordered by the total value of improvable recoverable lift, and a set number of opportunities are presented to the user (in graphical or tabular format).

Of course, it should be understood by those skilled in the art that other clustering techniques and methods may also be readily employed instead of decision trees.

### V. System Embodiments

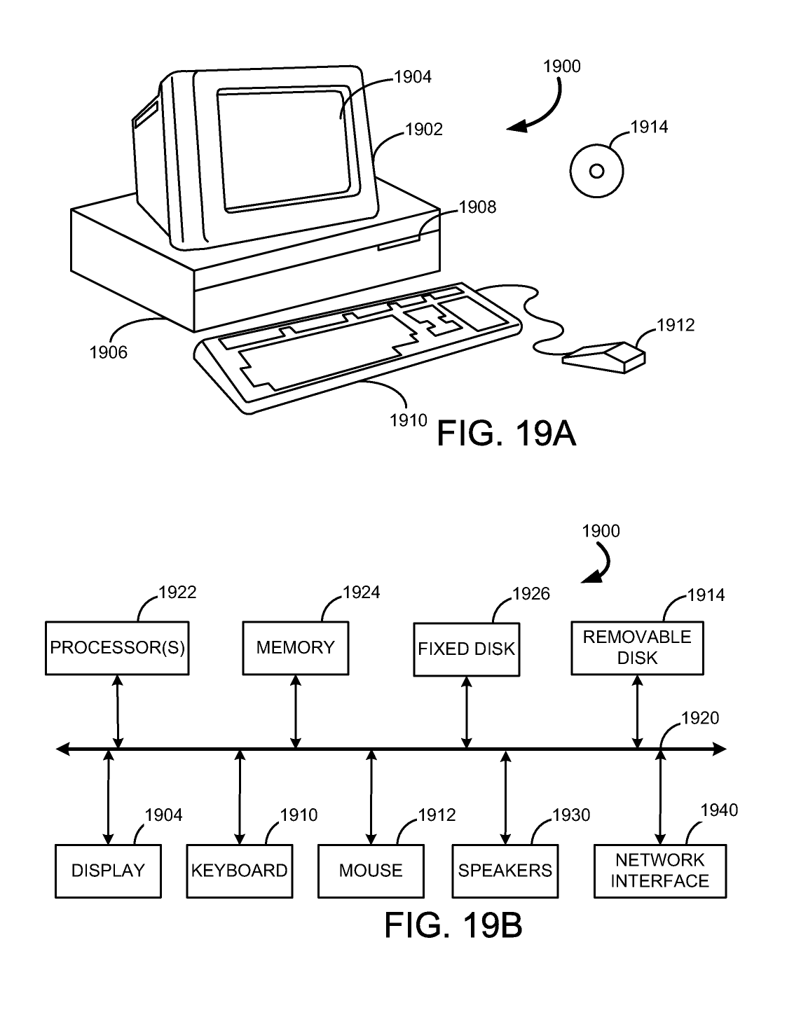

FIGS. 19A and 19B illustrate a Computer System 1900, which is suitable for implementing embodiments of the present invention. FIG. 19A shows one possible physical form of the Computer System 1900. Of course, the Computer System 1900 may have many physical forms ranging from a printed circuit board, an integrated circuit, and a small handheld device up to a huge super computer. Computer system 1900 may include a Monitor 1902, a Display 1904, a Housing 1906, a Disk Drive 1908, a Keyboard 1910, and a Mouse 1912. Disk 1914 is a computer-readable medium used to transfer data to and from Computer System 1900.

FIG. 19B is an example of a block diagram for Computer System 1900. Attached to System Bus 1920 are a wide variety of subsystems. Processor(s) 1922 (also referred to as central processing units, or CPUs) are coupled to storage devices, including Memory 1924. Memory 1924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 1926 may also be coupled bi-directionally to the Processor 1922; it provides additional data storage capacity and may also include any of the computer-readable media described below. Fixed Disk 1926 may be used to store programs, data, and the like and is typically a secondary storage medium (such as a hard disk) that is slower than primary storage. It will be appreciated that the information retained within Fixed Disk 1926 may, in appropriate cases, be incorporated in standard fashion as virtual memory in Memory 1924. Removable Disk 1914 may take the form of any of the computer-readable media described below.

Processor 1922 is also coupled to a variety of input/output devices, such as Display 1904, Keyboard 1910, Mouse 1912 and Speakers 1930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 1922 optionally may be coupled to another computer or telecommunications network using Network Interface 1940. With such a Network Interface 1940, it is contemplated that the Processor 1922 might receive information from the network, or might output information to the network in the course of performing the above-described price analytics on normalized transactions. Furthermore, method embodiments of the present invention may execute solely upon Processor 1922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, systems and methods for price analysis on normalized transactions are provided. While a number of specific examples have been provided to aid in the explanation of the present invention, it is intended that the given examples expand, rather than limit the scope of the invention. Although sub-section titles have been provided to aid in the description of the invention, these titles are merely illustrative and are not intended to limit the scope of the present invention.

While the systems and methods have been described in functional terms, embodiments of the present invention may include entirely hardware, entirely software or some combination of the two. Additionally, manual performance of any of the methods disclosed is considered as disclosed by the present invention.

While this invention has been described in terms of several preferred embodiments, there are alterations, permutations, modifications and various substitute equivalents, which fall within the scope of this invention. It should also be noted that there are many alternative ways of implementing the methods and systems of the present invention. It is therefore intended that the following appended claims be interpreted as including all such alterations, permutations, modifications, and various substitute equivalents as fall within the true spirit and scope of the present invention.

What is claimed is:

1. A method for price point analysis, useful in association with an integrated price management system, the method comprising:
analyzing source transactions to generate a data set of transactions;
identify a primary waterfall cause of the data set; and
generating, using a processor, a discrete root dimensional cause classification by setting the primary waterfall cause as a dependent variable and all other dimensions as independent variables, and clustering transactions along dimensional boundaries that best explain the primary waterfall cause.

2. The method of claim 1, wherein the analyzing transactions further comprises:
grouping source transactions by a split dimension;
calculating values for each group based on a decision test value percentiles applied to a distribution of derived decision measures; and
filtering out groups whose derived decision measures are not within the lift values.

3. The method of claim 1, wherein the identifying a primary waterfall cause comprises:
defining waterfall measures;
defining waterfall lift targets for each waterfall measure;
calculating a gap between each waterfall lift target and the corresponding waterfall measure; and
assigning the waterfall measure with the largest gap as the primary waterfall cause.

4. The method of claim 1, further comprising pre-processing including the steps of:
grouping raw transactions by an aggregation dimension;
calculating a discrimination value for each group of raw transactions;
assigning all raw transactions as source transactions if the discrimination value is below a threshold; and
filtering the groups by percentile limits and conditional filters if the discrimination value is above the threshold, and assigning the filtered transactions as source transactions.

5. The method of claim 1, wherein the clustering of the transactions forms nodes on a decision tree, and wherein each node in the decision tree is split by all possible split dimensions.

6. The method of claim 5, wherein the nodes that are unable to be split further are leaf nodes.

7. The method of claim 6, further comprising determining if leaf nodes are opportunities, wherein opportunities have more than one transaction in the leaf node, and if there is one primary waterfall cause which is both the highest occurrence and has the greatest total improvable waterfall lift.

8. The method of claim 7, further comprising determining for each opportunity the split dimension that created it, the number of transaction within it, the total value of recoverable lift for the opportunity, the percentage of recoverable lift for the opportunity, the dominant waterfall cause for the opportunity, the improvable recoverable lift for the opportunity, and the improvable waterfall lift for the opportunity.

9. The method of claim 8, further comprising sorting the opportunities by improvable waterfall lift.

10. The method of claim 9, further comprising displaying the opportunities with the greatest improvable waterfall lift.

11. A price point analyzer comprising:
an analyzer configured to analyze source transactions to generate a data set of transactions;
a root waterfall classifier configured to identify a primary waterfall cause of the data set; and
a discrete classifier, including a processor, configured to generate a discrete root dimensional cause classification by setting the primary waterfall cause as a dependent variable and all other dimensions as independent variables, and clustering transactions within the data set by split dimensions.

12. The system of claim 11, wherein the analyzer is further configured to:
group source transactions by a split dimension;
calculate a decision derived measure for each transaction group;
filter out groups with less than a first threshold of measures to generate remaining groups; and
filter transactions within the remaining groups by a decision value limit to generate the data set of transactions.

13. The system of claim 11, wherein the root waterfall classifier is further configured to:
define waterfall measures;
define waterfall lift targets for each waterfall measure;
calculate a gap between each waterfall lift target and the corresponding waterfall measure; and
assign the waterfall measure with the largest gap as the primary waterfall cause.

14. The system of claim 11, further comprising a pre-processor configured to:
group raw transactions by an aggregation dimension;
calculate a discrimination value for each group of raw transactions;
assign all raw transactions as source transactions if the discrimination value is below a threshold; and
filter the groups by percentile limits and conditional filters if the discrimination value is above the threshold, and assigning the filtered transactions as source transactions.

15. The system of claim 11, wherein the clustering of the transactions forms nodes on a decision tree, and wherein each node in the decision tree is split by all possible split dimensions.

16. The system of claim 15, wherein the nodes that are unable to be split further are leaf nodes.

17. The system of claim 16, wherein the discrete classifier is further configured to determine if leaf nodes are opportunities, wherein opportunities have more than one transaction in the leaf node, and if there is one primary waterfall cause which is both the highest occurrence and has the greatest total improvable waterfall lift.

18. The system of claim 17, wherein the discrete classifier is further configured to determine, for each opportunity, the split dimension that created it, the number of transaction within it, the total value of recoverable lift for the opportunity, the percentage of recoverable lift for the opportunity, the dominant waterfall cause for the opportunity, the improvable recoverable lift for the opportunity, and the improvable waterfall lift for the opportunity.

19. The system of claim 18, wherein the discrete classifier is further configured to sort the opportunities by improvable waterfall lift.

20. The system of claim 19, wherein the discrete classifier is further configured to display the opportunities with the greatest improvable waterfall lift.
